(19) United States
(12) Patent Application Publication
(10) Pub. No.: US 2023/0406189 A1
(43) Pub. Date: Dec. 21, 2023

(54) TRAILER

(71) Applicant: ESCAPOD TRAILERS LLC, Coalville, UT (US)

(72) Inventors: Christopher Hudak, Coalville, UT (US); Christopher Eckel, Salt Lake City, UT (US)

(73) Assignee: ESCAPOD TRAILERS LLC, Coalville, UT (US)

(21) Appl. No.: 18/338,939

(22) Filed: Jun. 21, 2023

Related U.S. Application Data
(60) Provisional application No. 63/354,149, filed on Jun. 21, 2022.

(51) Int. Cl. B60P 3/32; B62D 63/08; B62D 29/04; B32B 27/36; B32B 5/02; B32B 27/12

(52) U.S. Cl. CPC B60P 3/32; B62D 63/08; B62D 29/043; B32B 27/36; B32B 5/02; B32B 27/12; B60G 3/14

(57) ABSTRACT

Apparatuses, systems, and methods are disclosed for a trailer. An apparatus includes a trailer frame and a body coupled to the trailer frame. The body includes a monocoque structure that is molded from a plurality of material layers. The molded body includes at least one access and a storage compartment located towards a tongue of the trailer frame.

### CROSS REFERENCE TO OTHER APPLICATIONS

This application claims the benefit of U.S. Provisional Patent Application No. 63/354,149 entitled “TRAILER” and filed on Jun. 21, 2022, for Christopher Hudak, et al., which is incorporated herein by reference.

### FIELD

This invention relates to recreational vehicles (“RVs”) and more particularly relates to camping trailers.

### BACKGROUND

Camping trailers are RVs that can be towed by a car or truck. Camping trailers are an alternative to traditional tent camping and allow a user to bring many of the comforts of home with them on road trips and camping expeditions. As camping trailers have grown more popular, sellers of camping trailers have developed numerous innovations and distinct styles of camping trailers have developed.

### BRIEF SUMMARY

Apparatuses, systems, and methods are disclosed for a trailer. In one embodiment, a trailer includes a trailer frame and a body coupled to the trailer frame. The body includes a monocoque structure that is molded from a plurality of material layers. The molded body includes at least one access and a storage compartment located towards a tongue of the trailer frame.

In one embodiment, the plurality of layers includes fiberglass matting that has a low-density polyethylene terephthalate (“PET”) core positioned between an inner layer and an outer layer of the plurality of layers of fiberglass matting such that the body is structurally rigid and insulated.

In one embodiment, the body includes at least one accessory point molded into the body, the at least one accessory point comprising one or more of a magnet, a hook, an eye, and a clip.

In one embodiment, the body includes a plurality of return flange mechanical gutters for each of the at least one accesses molded into the body, the plurality of return flange mechanical gutters configured to capture moisture and direct it away from the trailer without additional sealing materials around the at least one access.

In one embodiment, the body is further molded to form at least one of an interior cabin, a rear galley, a rear galley access, a window, a roof rack system, and a roof access.

In one embodiment, the rear galley includes a kitchen, the kitchen including one or more of a sink, a stove, a cooler, a table, and one or more cabinets.

In one embodiment, the table forms a removable cabinet door for a cabinet of the rear galley, the table including an adjustable fold-out leg on a first side and a mounting point along an edge of the table for mounting to a side of the trailer.

In one embodiment, the edge of the table that mounts to the side of the body includes a metal edge that selectively couples to a corresponding mounting point on the fender.

In one embodiment, the roof rack system includes a pair of oppositely located elongated protrusions on the roof of the body that are molded as part of the body and provide an elevated flat surface for mounting items to the roof.

In one embodiment, the trailer includes at least one adjustable rail that is couplable to the pair of elongated protrusions and spans a width of the roof between the pair of elongated protrusions for securing items mounted to the roof.

In one embodiment, the trailer includes a trailing arm style suspension system coupled to the frame, the suspension system including Delrin bushings, eccentric bolts for toe and camber wheel alignment, an angled shock-in-spring mount, and built-in rock sliders for protection of the suspension components.

In one embodiment, the trailer includes a hidden galley hinge system that mounts to an interior of the body and the rear galley hatch door such that when activated the hinge extends outward and upward, clearing the galley hatch door from the rest of the body.

In one embodiment, the trailer includes a solar panel coupled to an exterior surface of the body for providing power to electrical components of the trailer.

In one embodiment, an interior of the trailer includes a plurality of storage compartments that include three upper storage cabinets and two lower storage cabinets, each storage cabinet having a hinged door.

In one embodiment, the middle upper cabinet door, when hinged open, folds down and rests onto an angle cut into the two lower cabinet doors, creating an angled surface for resting an object, the two lower cabinets including metal plates that are selectively coupled to two hidden magnets in the middle upper cabinet door.

In one embodiment, the at least one access includes a doorway to an interior of the trailer, an interior edge of the doorway lined with magnetic material for attaching accessories along the doorway.

In one embodiment, the trailer includes a door for the doorway, the door comprising a window that includes an edge that is lined with magnetic material for attaching accessories on the window.

In one embodiment, the accessories include a screen that has magnetic material along an edge of the screen and is sized to fit one of the doorway and the window.

In one embodiment, a system is disclosed that includes a trailer frame and a body coupled to the trailer frame, the body comprising a monocoque structure that is molded from a plurality of material layers. In one embodiment, the body is molded to include at least one access and a storage compartment located towards a tongue of the trailer frame and a plurality of return flange mechanical gutters for each of the at least one accesses configured to capture moisture and direct it away from the trailer without additional sealing materials around the at least one access. In one embodiment, the system includes a trailing arm style suspension system coupled to the trailer frame and each wheel, the trailing arm style suspension system including independent suspension for each wheel of the trailer.

A method is disclosed for forming a trailer body including creating a master body mold by layering a plurality of fiberglass matting layers and a PET core, injecting the master body mold with resin, vacuum sealing the master body mold, curing the master body mold for a predetermined period of time.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A depicts a perspective view of an embodiment of a trailer in accordance with the subject matter described herein;

FIG. 1B depicts another perspective view of an embodiment of the trailer in accordance with the subject matter described herein;

FIG. 1C depicts a side view of an embodiment of the trailer in accordance with the subject matter described herein;

FIG. 1D depicts another side view of an embodiment of the trailer in accordance with the subject matter described herein;

FIG. 2A depicts a perspective view of an embodiment of a frame of a trailer in accordance with the subject matter described herein;

FIG. 2B depicts another perspective view of an embodiment of the frame with a floor attached in accordance with the subject matter described herein;

FIG. 3A depicts a perspective view of an embodiment of the interior structure of the trailer in accordance with the subject matter described herein;

FIG. 3B depicts a side view of an embodiment of the interior structure of the trailer in accordance with the subject matter described herein;

FIG. 4 depicts a perspective view of an embodiment of a trailer body in accordance with the subject matter described herein;

FIG. 5 depicts a perspective view of one embodiment of a storage box of a trailer body in accordance with the subject matter described herein;

FIG. 6A depicts a front view of a trailer in accordance with the subject matter described herein;

FIG. 6B depicts a rear view of a trailer in accordance with the subject matter described herein;

FIG. 7A depicts one embodiment of a suspension system for a trailer in accordance with the subject matter described herein;

FIG. 7B depicts one embodiment of a suspension system for a trailer in accordance with the subject matter described herein;

FIG. 8A depicts a perspective view of one embodiment of a trailer with its doors open in accordance with the subject matter described herein;

FIG. 8B depicts a perspective view of one embodiment of a trailer with its doors open in accordance with the subject matter described herein;

FIG. 9 depicts one embodiment of a hinge system for a trailer in accordance with the subject matter described herein;

FIG. 10 depicts a rear view of one embodiment of the rear galley of a trailer in accordance with the subject matter described herein;

FIG. 11A depicts one embodiment of a stowed table for a trailer in accordance with the subject matter described herein;

FIG. 11B depicts one embodiment of a stowed table installed on a trailer in accordance with the subject matter described herein;

FIG. 12A depicts a perspective view of an embodiment of a trailer with attached accessories in accordance with the subject matter described herein;

FIG. 12B depicts a perspective view of an embodiment of a trailer with attached accessories in accordance with the subject matter described herein;

FIG. 12C depicts a perspective view of an embodiment of a trailer with attached accessories and doors open in accordance with the subject matter described herein;

FIG. 12D depicts a perspective view of an embodiment of a trailer with attached accessories and doors open in accordance with the subject matter described herein;

FIG. 13A depicts a rear cutout view of an embodiment of an interior of a trailer in accordance with the subject matter described herein;

FIG. 13B depicts a side cutout view of an embodiment of an interior of a trailer in accordance with the subject matter described herein;

FIG. 14 depicts an embodiment of a roof rack for a trailer in accordance with the subject matter described herein;

FIG. 15A depicts a top view of an embodiment a trailer in accordance with the subject matter described herein;

FIG. 15B depicts a bottom view of an embodiment of a trailer in accordance with the subject matter described herein; and

FIG. 16 depicts a schematic flow chart diagram of one embodiment of a method for forming a trailer body in accordance with the subject matter described herein.

### DETAILED DESCRIPTION

In general, the subject matter herein describes a trailer that can be used for camping. In one embodiment, the trailer is a teardrop-style camping trailer. As used herein, a teardrop-style camping trailer may refer to a streamlined, compact, lightweight, trailer that gets its name from its teardrop profile. Teardrop-style camping trailers provide an alternative to large, cumbersome RVs that limit access to different areas and experiences. In recent years, this minimalist product has found newcomers looking to upgrade from tent-camping, but not limit their experiences by the bulk and cheap quality/aesthetic of the traditional RV. The shift has gone from “RV-ing” to “Overlanding,” and a new generation of vehicles are necessary to support the industry.

As used herein, “Overlanding” describes self-reliant adventure travel to remote destinations where the journey is the primary goal. Typically, but not exclusively, accommodated by mechanized off-highway capable transport where the principal form of lodging is camping. While expedition is defined as a journey with a purpose, overlanding sees the journey as the purpose.

Traditional small campers are made with materials that require slow manufacturing methods (e.g., plywood core, aluminum exterior, exposed fasteners) and are hard to build rugged enough to withstand the elements for years. Conventional solutions on the market are either built with inferior form, function, or antiquated materials and processes.

In addition to the cabin construction, the frame and suspension of conventional trailers in this industry are often leaf-spring design or rubber torsion axles that are ill-equipped to stand up to the rigors of off-road travel.

Conventional solutions for building a trailer that can withstand Overlanding's demands include over-building, often using excessive amounts of heavy metals or redundant body construction that adds unnecessary weight to the unit, making it cumbersome (and in many cases impossible) to pull with common tow vehicles.

The subject matter disclosed herein describes an apparatus for an off-road camper trailer that improves upon conventional teardrop-style camping trailers. In one embodiment, the apparatus includes a monocoque trailer body made of layers of fiberglass with a low-density polyethylene (“PET”) core creating an insulated and rigid trailer body. In one embodiment, the trailer body is formed using a vacuum bag/infused fiberglass manufacturing process to create a strong, lightweight, aesthetically unique, and functionally superior trailer body. The insulated body houses the components and accessories needed for overlanding (e.g., water, air, heat, power, refrigeration, storage) within the internal structure of the body, reducing risk of exposure/damage, and allowing unlimited four-season use.

In one embodiment, the trailer body is mounted to a light-weight frame. The frame, in one embodiment, includes a frame and a trailing arm style suspension that enables high clearance and superior damped suspension for travel on inconsistent terrain.

In one embodiment, the body further comprises one or more entry door openings, a rear galley hatch opening, and a stargazing window opening. In one embodiment, the entry door openings and the galley hatch opening include a return flanged mechanical gutter system built into the body such that any water that enters the gutter is directed down and away from the trailer.

In one embodiment, customer-centric add-ons are installed including, for example, a full queen-sized bed, heater interior storage, a full kitchen galley with sink, stove, and cooled food storage, as well as mounted solar panels and functional roof racks that make the trailer incredibly capable for its size and weight.

Thus, the subject matter herein describes a trailer that is a minimal home on wheels, able to follow the user's tow vehicle wherever it goes, making camp setup easy and convenient. Integrated storage allows the user to take more on their trips and have less setup time when they get there, ultimately allowing easier and safer access to more places for individuals and families who want the adventure of camping and the convenience of RVing.

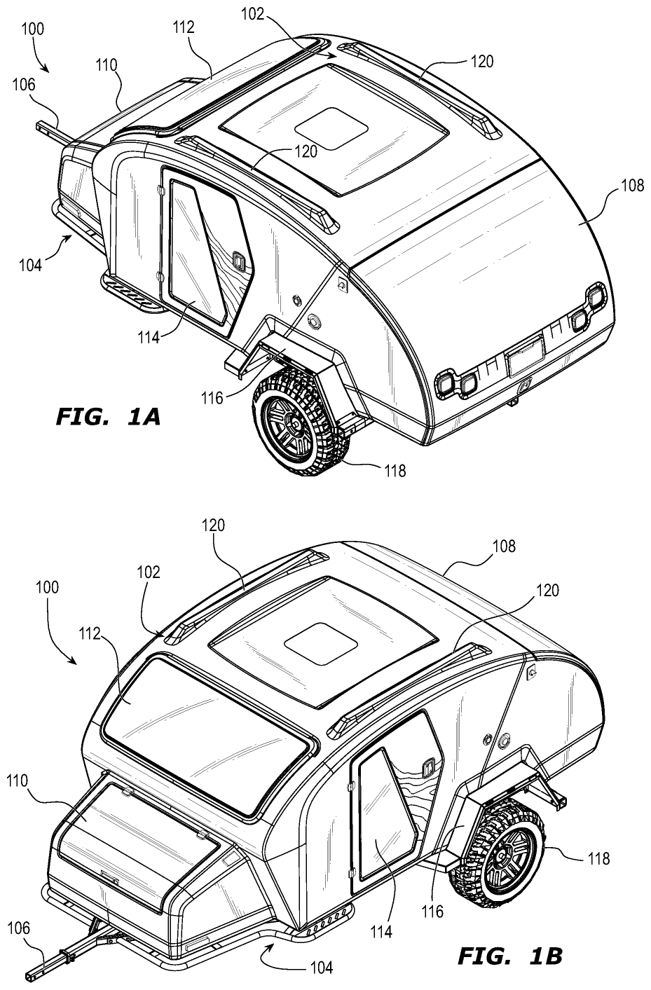

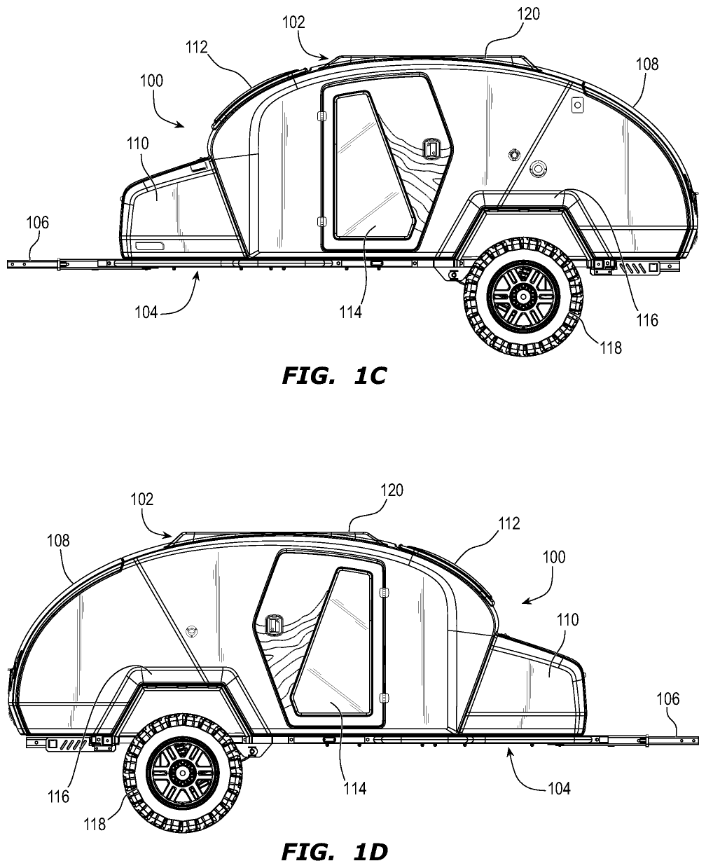

FIGS. 1A and 1B depict perspective views of embodiments of a camping trailer 100. In one embodiment, a monocoque trailer body 102 or shell is coupled to a trailer frame 104. As used herein, a monocoque body or shell may refer to a structural system in which loads are supported by an object's external skin. In one embodiment, the monocoque trailer body 102 is coupled to the frame 104, e.g., via fasteners, adhesives, clips, snaps, or a combination thereof. In one embodiment, the trailer body 102 is molded, formed, manufactured, or otherwise made from a plurality of material layers. The layers may include a plurality of fiberglass matting that has a low-density polyethylene terephthalate (“PET”) core positioned between an inner layer and an outer layer of the plurality of layers of fiberglass matting such that the body is structurally rigid and insulated.

In such an embodiment, the trailer body 102 is formed by creating a master body mold by layering the plurality of fiberglass matting layers and the PET core, injecting the master body mold with resin, vacuum sealing the master body mold, and curing the master body mold for a predetermined period of time.

In certain embodiments, at least one accessory point is molded into the body. An accessory point, as used herein, may be an area or portion of the external or internal surface of the body 102 that allows for attaching, coupling, connecting, hanging, or the like various accessors to the body 102. In certain embodiments, at least one accessory point includes one or more of a magnet, a hook, an eye, a clip, and/or the like that can be used to attach different accessories such as flashlights, phones or other devices, hats, clothing, bags, cooking accessories, or the like to the body 102. The accessory point may include a portion of the body that is molded where an attachment device can be installed such as a hook, magnet, or the like. In other embodiments, attachment devices may be installed during the molding/forming process (e.g., a hook may be installed in the body during the molding/forming process).

In one embodiment, one or more accesses or entryways are molded into the body 102. The one or more accesses may include doors, windows, ports, or the like, which may be selectively opened and closed. In such an embodiment, a plurality of return flange mechanical gutters for each of the at least one accesses is molded into the body 102. As used herein, the plurality of return flange mechanical gutters are configured to capture moisture at an access/pre-formed point and direct it away from the trailer without additional sealing materials around the at least one access, as described in detail below with reference to FIG. 5.

The body 102 may be formed or molded to form/shape various compartments, accesses, or the like located within an interior of the body 102 and/or on an exterior of the body 102. For instance, a storage compartment 110 may be formed towards the front of the body 102 and towards the tongue of the frame 104. Further, the body 102 may form an interior cabin, a rear galley, a rear galley access 108, a window 112, a roof rack system 120 that includes one or more elongated protrusions, and a roof access.

In one embodiment, a trailer hitch 106 allows the trailer 100 to be towed by a car or truck. In certain embodiments, two oversized, all-terrain or offroad tires 118 are coupled to an axle that is mounted to the frame 104 and provide traction and high clearance to enable the trailer 100 to pass over uneven surfaces. In one embodiment, a fender 116 is coupled to each side of the trailer frame 104 to protect the tires 118, to act as a step, or to act as a table extension.

In one embodiment, a storage door provides access to the storage compartment 110. In one embodiment, an entry door 114 provides access to an interior of the trailer body 102. A galley door 108, in one embodiment, provides access to a rear galley. In one embodiment, a window 112 allows for light to enter the interior of the trailer. One or more elongated protrusions 120, in one embodiment, on the roof allow for items such as a roof rack to be mounted to the roof. In certain embodiments, an interior edge of the windows 112, entry doors 114, or the like are lined with magnetic material for attaching accessories along the windows 112 or entry doors 14, including screens, curtains, or the like that include corresponding magnetic material along their edges.

FIGS. 1C and 1D depict left and right side views, respectively, of an embodiment of the trailer 100, described above with reference to FIGS. 1A and 1B.

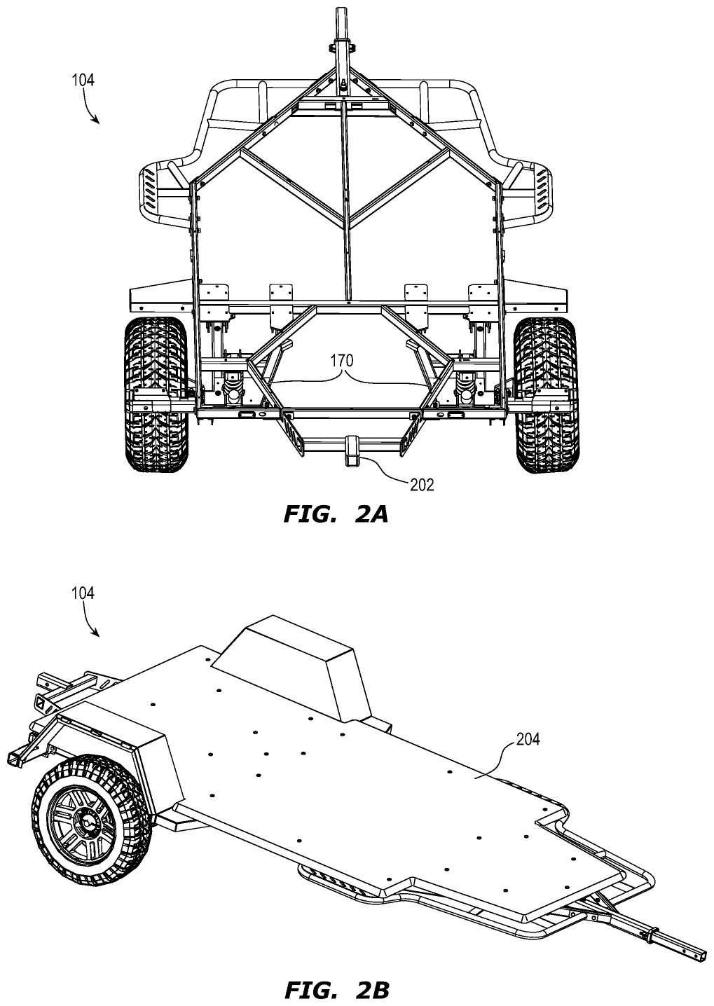

FIG. 2A depicts one embodiment of the frame 104. In one embodiment, the frame 104 is made of laser-cut, 2×1-inch tube steel then hot-dip galvanized, for added protection against external environmental elements. One of skill in the art will recognize, in light of this disclosure, that various sizes and materials may be used for the frame 104, such as aluminum.

In one embodiment, the frame 104 includes various mounting points for attaching different accessories to customize the trailer 100. For instance, the frame 104 may include mounting points for rock rails, steps, extra receiver tubes, and/or the like. The mounting points may be shaped to receive accessories that include correspondingly shaped attachment points, e.g., square metal tubing (similar to a receiver hitch), and corresponding holes/openings for securing the accessories with pins.

The fenders 116 may be bolted to the frame 104 and inset into the wheel-well, e.g., by about six inches, which minimizes protrusion and maximizes usable interior space. The frame 104 may include a rear hitch receiving tube 202 for mounting a hitch for pulling an additional trailer, attaching a hitch-mounted cargo rack, a bike rack, or the like. Furthermore, a trailing arm suspension system 170 may be coupled to the frame 104 to provide independent suspension to each wheel/tire coupled to the frame 104, as described in more detail below.

FIG. 2B depicts one embodiment of the frame 104 with a floor mold 204 attached, e.g., bolted to the frame 104. In one embodiment, the floor mold 204 forms the floor of the body 102 that is coupled to the frame 104 to form the complete trailer 100. In certain embodiments, the floor mold 204 is made or manufactured in the same manner as the monocoque trailer body 102, e.g., may be made of multiple layers of fiberglass material. Other types of materials may be used for the flooring, including wood, aluminum, steel, vinyl, and/or the like.

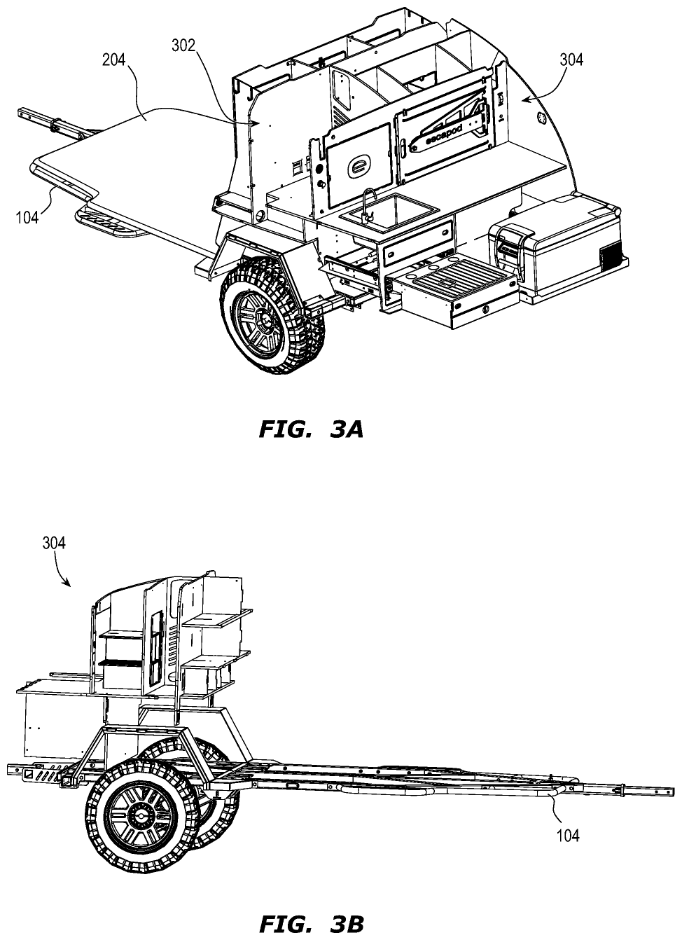

FIG. 3A depicts various internal structural and mechanical components of the trailer 100, which are mounted to the frame 104 and/or the floor mold 204. In one embodiment, the internal structures are made of high-density polyethylene (“HDPE”) and lightweight honeycomb composite that is computer numerical control (“CNC”) precision cut with mortise and tenon construction for added strength. The internal structural components may divide an interior of the body 102 into different areas or sections such as the storage compartment 110, the main cabin area, a mechanical area 302, and a rear galley area 304.

In one embodiment, the mechanical area 302 may include various mechanical parts such as one or more batteries (or other power sources) and/or other electrical components; heating, ventilation, and air conditioning (“HVAC”) components; a water tank and other plumbing components; and/or the like. For instance, the power source may include a 100 amp hour VPR 4EVER lithium battery powers the 12V system throughout the trailer, such as strategically placed, dimmable, warm-light LED lighting in the cabin and galley, ground lights beneath each entry door, and reading lights above each nightstand. In one embodiment, the trailer 102 may include USB ports (or other charging and data ports) in both the galley and the cabin.

In certain embodiments, the HVAC system may include a fan, e.g., a standard four-speed MaxxAir exhaust fan, as well as integrated forced-air heating ducts behind a soft-touch molded headliner keeps the cabin climate-controlled. In one embodiment, a water tank provides a usable capacity of water, e.g., 21-gallons of water. The water tank may be nested within the insulated trailer, reducing concerns over freezing temperatures. Combined with a unique water cut-off, the water system may be used year-round. In certain embodiments, a water fill port is provided on the side of the trailer to refill the water tank. FIG. 3B illustrates a perspective view of the internal structural components of the trailer 100 depicted in FIG. 3A.

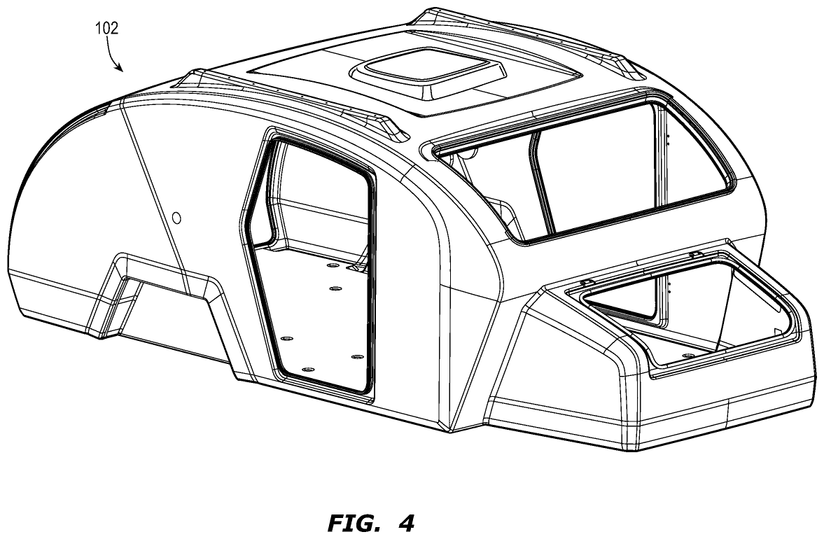

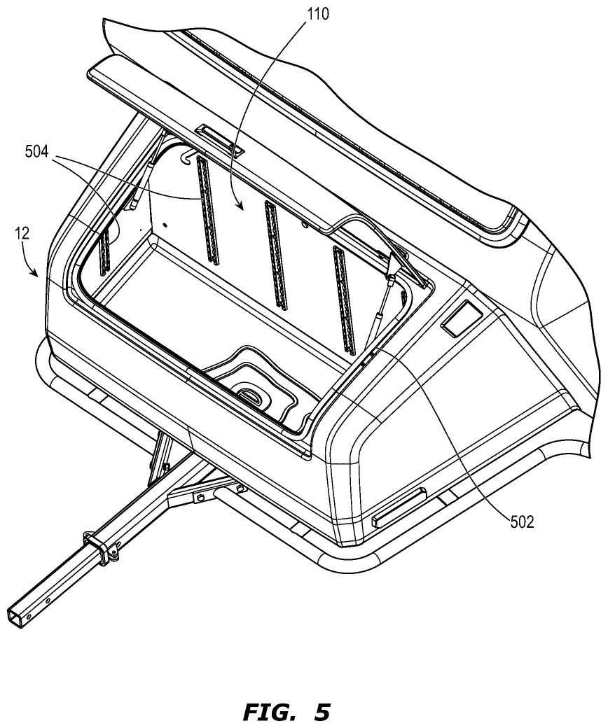

FIG. 4 depicts one embodiment of the trailer body 102, or shell, that is coupled or attached to the frame 104 and/or the floor mold 204. The body 102, as described above, is made of a single or unitary composite fiberglass shell. Its stiffness comes from the unique PET core, which may be made from recycled material such as recycled milk cartons. Molded rain gutters direct water away from the access points, e.g., the hatch, window, side-doors, and/or the like. Further, the body 102 may not include internal structural elements such as wood, which alleviates concerns about the potential for mold and rot.

FIG. 5 depicts one embodiment of the storage compartment 110 that is formed as part of the body 102 and located towards the front of the body 102. In one embodiment, molded, mechanical gutters 502 (e.g., channels around accesses, doors, windows, or the like) are formed as part of the body 102 around the rim of the storage compartment 110 to direct moisture away from the storage compartment 110, similar to other accesses on the body 102, such as the doors, windows, or the like. Within the storage compartment 110, various rails 504 or other attachment points may be provided for securing items within the compartment 110 such as propane tanks, cargo, outdoor gear, and/or the like using straps, bungees, ropes, strings, or the like.

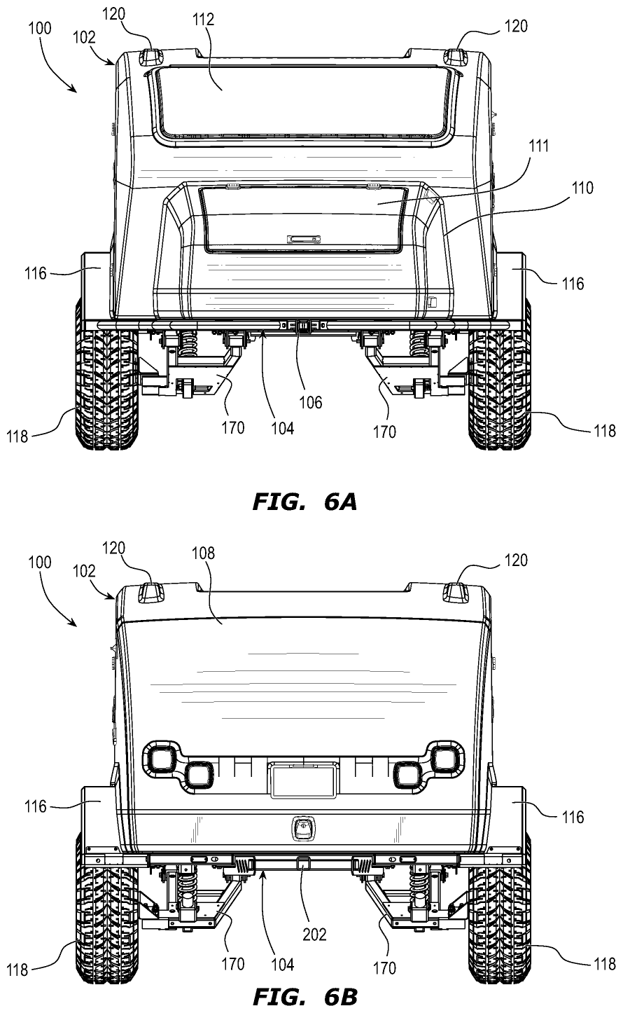

FIG. 6A depicts a front view of the trailer 100, e.g., a view looking at the trailer from the end of the frame 104 with the trailer hitch 106. As shown in FIG. 6A, the monocoque trailer body 102 may form a storage compartment 110, e.g., a storage box, at the front of the trailer 100. The storage compartment 110 may be accessed via an external storage door 111, or, in some embodiments, may be accessed from an interior of the trailer body 102, e.g., via an interior access panel.

FIG. 6B depicts a rear view of the trailer 100, e.g., a view looking at the rear galley. In one embodiment, the rear of the trailer 100 includes a galley that is accessible via a galley door 108. The galley door 108 may be a hatch-style door with the hinges located near the top of the door and the door latch near the bottom, which secures the galley door 108 to the trailer body 102 and/or frame 104. In one embodiment, the trailer body 102 may be molded to form cutouts, indentations, formations, and/or the like for one or more trailer lights 113 (e.g., taillights), a license plate 115, and/or the like. Further, in one embodiment, the frame 104 may include a rear hitch receiver 202 for securing a hitch for coupling another trailer, a hitch-mounted cargo rack or other hitch-mounted accessories, and/or the like.

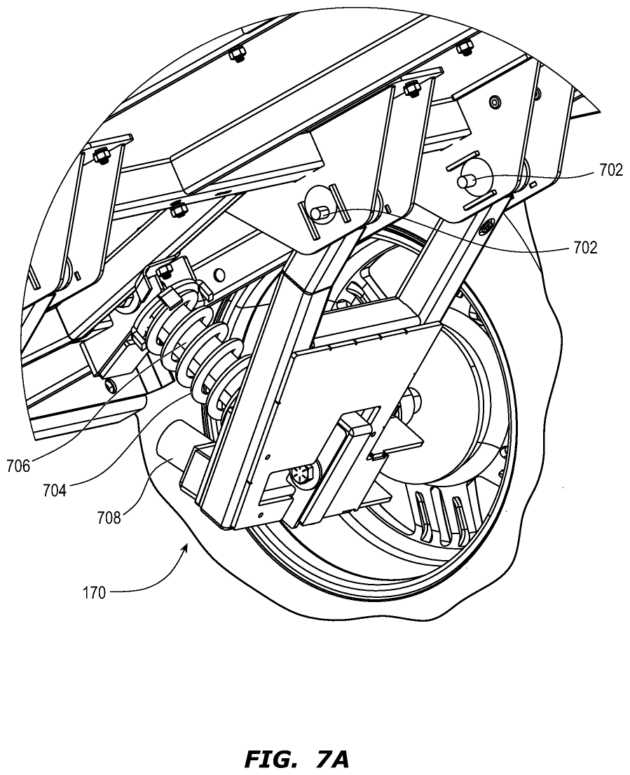

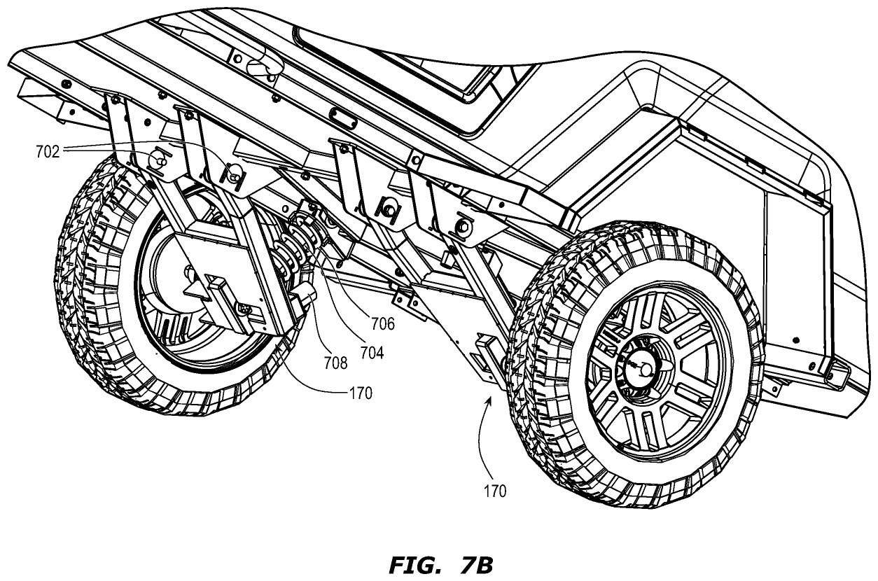

FIGS. 7A and 7B depict one embodiment of a trailing arm suspension system 170. In one embodiment, the trailing arm suspension system 170 is attached to an underside of the trailer frame 104. The trailing arm suspension system 170, in one embodiment, includes milled bushings (e.g., Delrin bushings), eccentric bolts 702 for easy wheel alignment of toe/camber, an angled shock-in-spring mount for maximum impact absorption 704, a damper 706 for preventing full compression of the spring and/or shock, a (rubber) bumper stop 708, and built-in rock sliders for protection of the components. In certain embodiments, the trailing arm suspension 170 allows for at least four inches of vertical travel and allows the trailer 100 to independently overcome obstacles it is towed over.

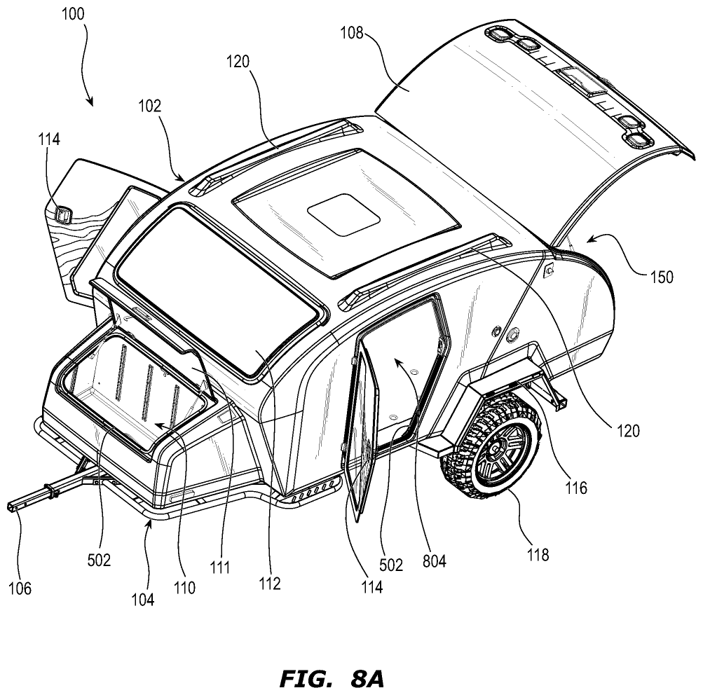

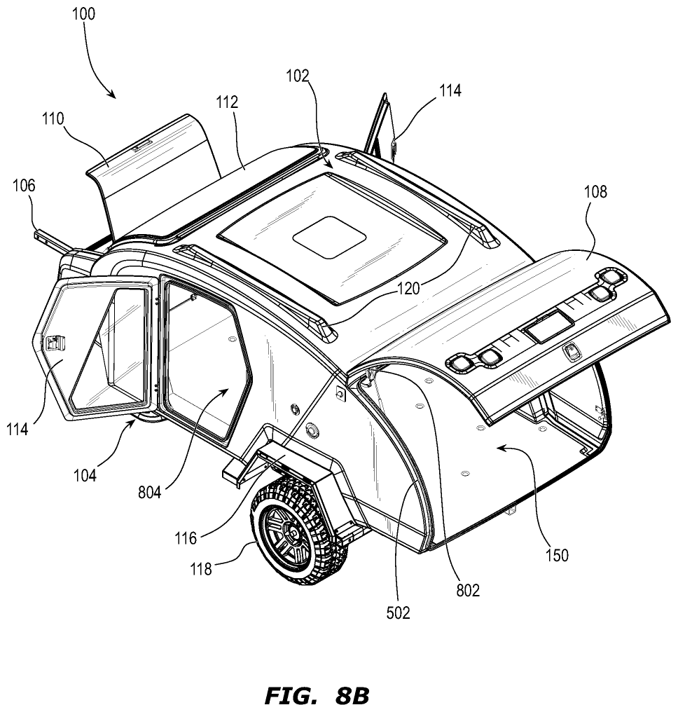

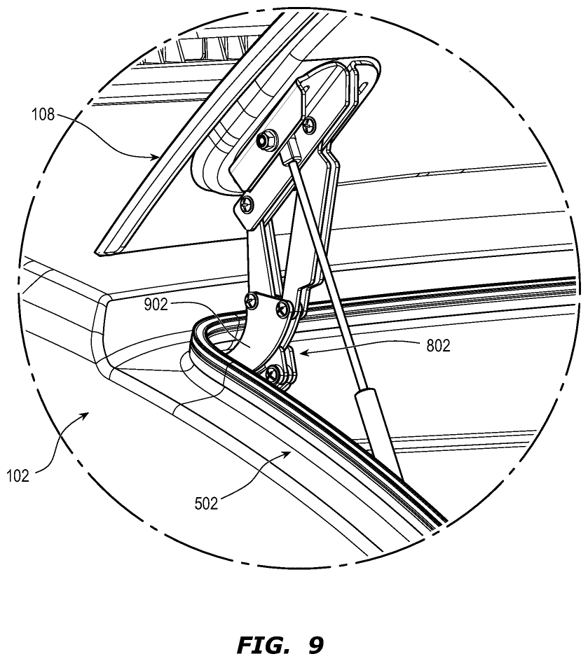

FIG. 8A shows the trailer 100 with doors/accesses 108, 111, 114 open. In one embodiment, a return flange mechanical gutter 502 (e.g., a channel) is formed around the doors 108, 111, 114, windows 112, and/or other accesses on the trailer body 102. In some embodiments, the return flange mechanical gutters 502 are formed as part of the monocoque body 102. Accordingly, moisture that enters the return flange mechanical gutters 502 is directed via the gutters 502 or channels and down and away from the trailer body 102. In one embodiment, entry doors 114 open to allow access into an interior cabin 804. In one embodiment, a galley door 108 provides access to a rear galley 150. In some embodiments, the rear galley 150 comprises a kitchen, as described below. The storage door 111, in one embodiment, allows access to a front storage compartment 110.

FIG. 8B depicts another view of the trailer 100 with doors/accesses 108, 111, 114 open. In this depiction of trailer 100, a hidden hinge system 802 can be seen. As further illustrated in FIG. 9, the hidden hinge system 802 is designed to protect the integrity of the monocoque trailer body 102 and the return flange mechanical gutters 502. In one embodiment, the hidden hinge system 802 comprises an articulating hinge 902 that mounts to the interior of the monocoque trailer body 102 and the rear galley hatch 108. When actuated, the hidden hinge system 802 extends outward and upward, clearing the galley door 108 from the rest of the monocoque trailer body 102, as opposed to a single point of rotation.

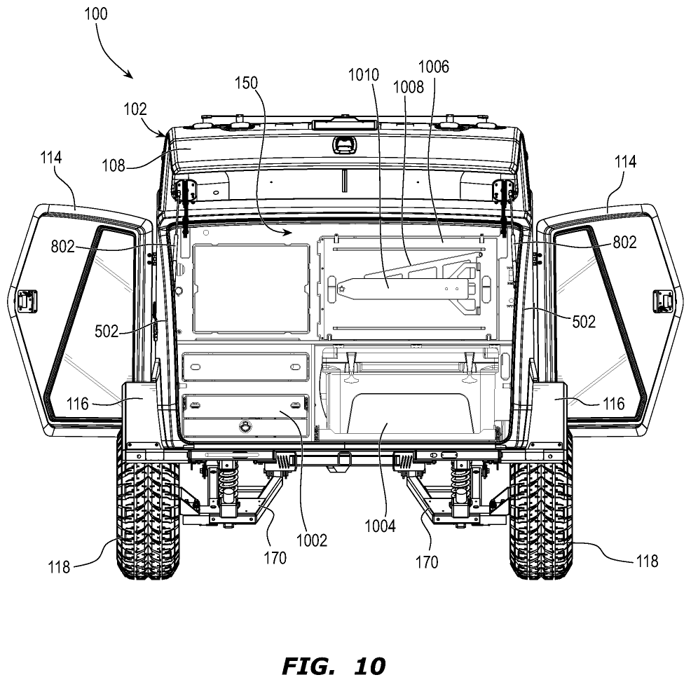

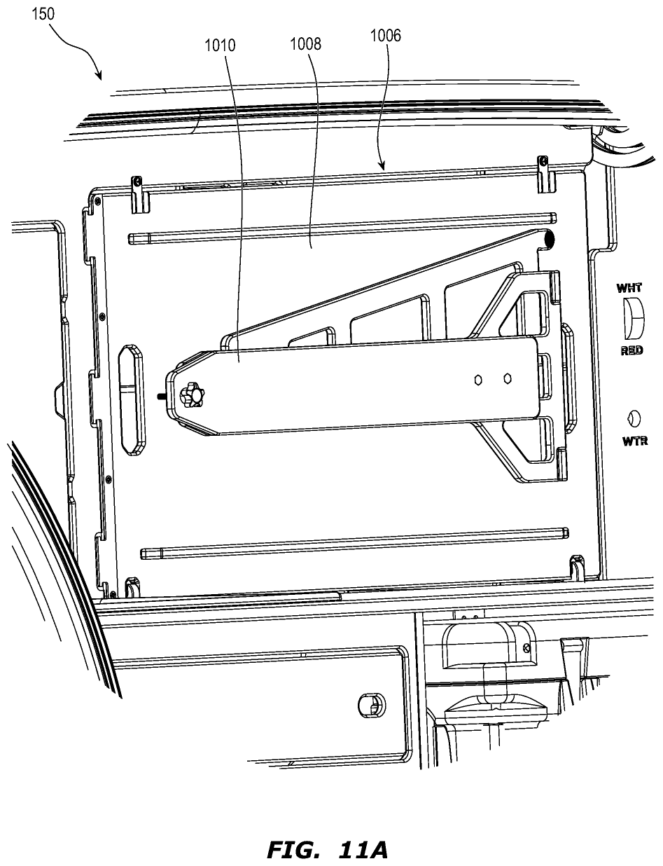

FIG. 10 depicts an embodiment of the trailer 100, as seen from the rear, with the galley door 108 open, exposing the interior of the rear galley 150. In some embodiments, the rear galley 150 of the trailer 100 includes a kitchen that includes a stove 1002, a refrigerator 1004 (or cooler), and a cabinet 1006 with a door that doubles as a stowable table 1008. The stowable table 1008, in one embodiment, is a door that comprises an adjustable fold-out table leg 1010.

In one embodiment, the rear galley 150 includes a full-size sink (12″ W×6″ D×14″ L), a stove (e.g., an ENO 2-burner stove (8000 BTUs)), and space for a cooler or refrigerator (e.g., a standard YETI® 75 cooler or an ARB 63 Fridge/Freezer). Further, in one embodiment, additional cabinet space is included in a hidden knife storage cabinet (e.g., an additional 7.5 cubic feet of space), a spice drawer, and modular shelving that allows for customization of the galley.

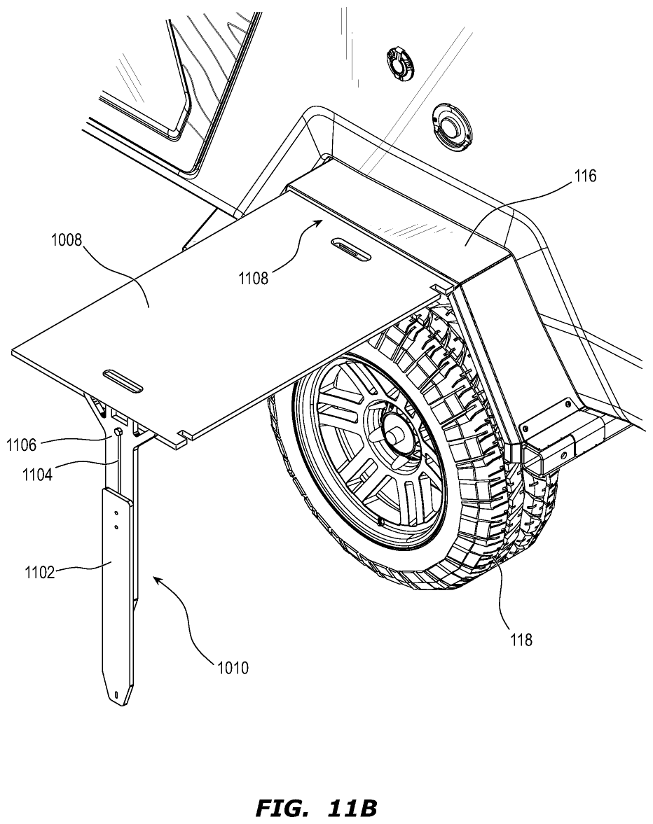

FIG. 11A depicts another embodiment of the stowable table 1008. The stowable table 1008, when stored in the rear galley 150, acts as a door or cover for the cabinet 1006. When removed, the table leg 1010 can be extended and used to prop up the table 1008 when it is used as a table, as shown in FIG. 11B.

FIG. 11B depicts one embodiment of the stowable table 1008 installed on the trailer 100. In one embodiment, the table leg 1010 folds out to support the table 1008 at one end. The table leg 1010 may include an extension member 1102 that slides along a groove 1104 of a stationary member 1106 and allows the table height to be adjusted to accommodate different terrain where the trailer 100 may be located. The extension member 1102 may be secured to the stationary member 1106 via a compression screw (not shown) on the rear side of the extension member 1102 (which also slides through the groove 1104), a snap system (e.g., a system that has predetermined points that the extension member 1102 can be extended to), a friction fit, and/or the like.

At the other end of the table 1008, the table 1008 may be secured to the trailer 100 at an attachment point 1108. In the depicted embodiment, the attachment point 1108 may be at the fender 116 and may include a magnetic coupling, a clip or snap coupling, a bolt coupling, or other mechanical means for coupling the table 1108 to the trailer 100. In one embodiment, the table 1008 may include a protrusion or a lip that fits into a slot or groove in the fender 116, e.g., a metal edge that selectively couples to a corresponding mounting lip, groove, slot, or edge on the fender 116. The trailer 100 may include other attachment points in addition to or alternative to the fender 116.

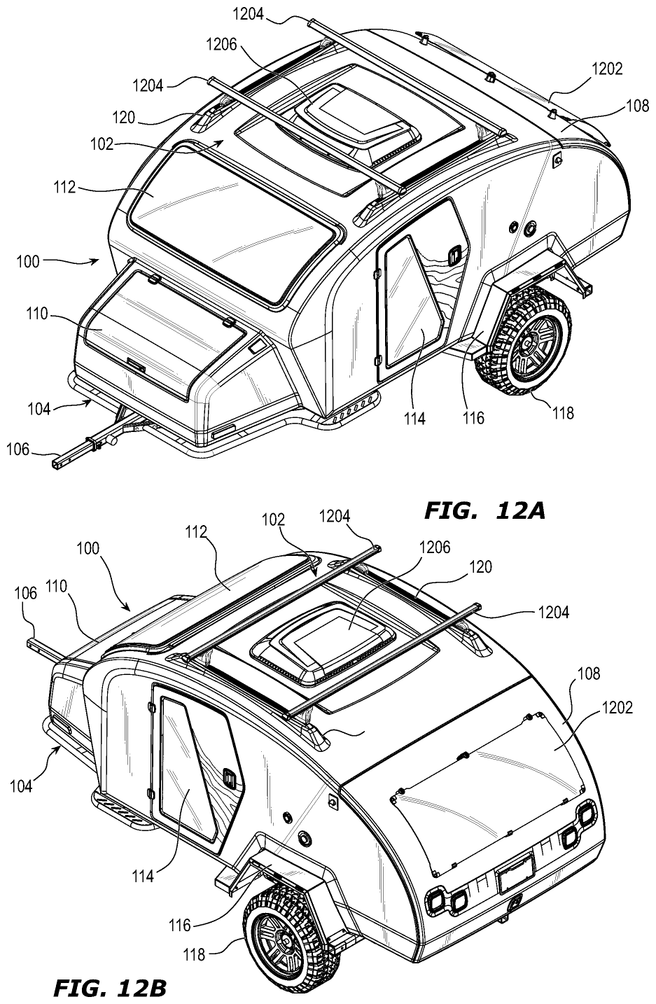

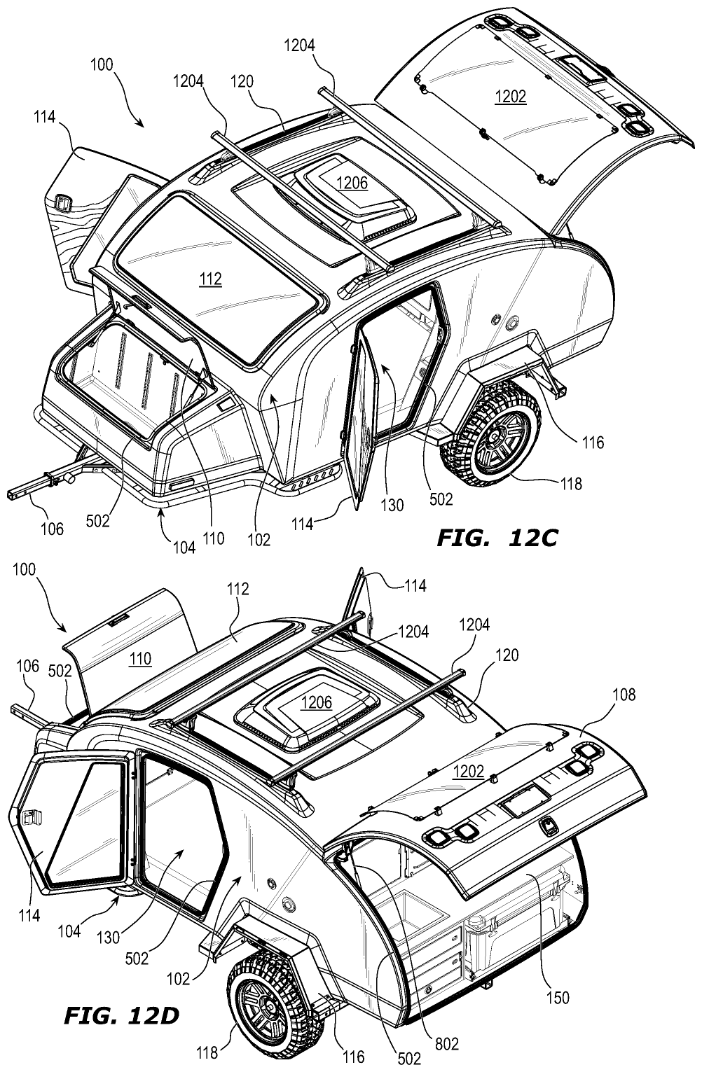

FIGS. 12A and 12B depict embodiments of the trailer 100 with additional features mounted to the trailer 100. In some embodiments, the trailer 100 comprises a solar panel 1202. The solar panel 1202, in one embodiment, provides electricity to the trailer 100, and may be used to charge batteries that the trailer 100 uses or to provide power to the trailer 100 in lieu of using the batteries. In some embodiments, the trailer 100 includes an adjustable roof rack 1204 that is mounted to the elongated protrusions 120, to create a roof rack system that can be adjusted backwards and forwards, as needed, based on the demands of the cargo being stored. In further embodiments, an air conditioning unit 1206 is mounted to the roof of the body 102 for cooling the interior cabin 130.

FIGS. 12C and 12D depict embodiments of the trailer 100 shown in FIGS. 12A and 12B with the doors open and additional features mounted to the trailer 100.

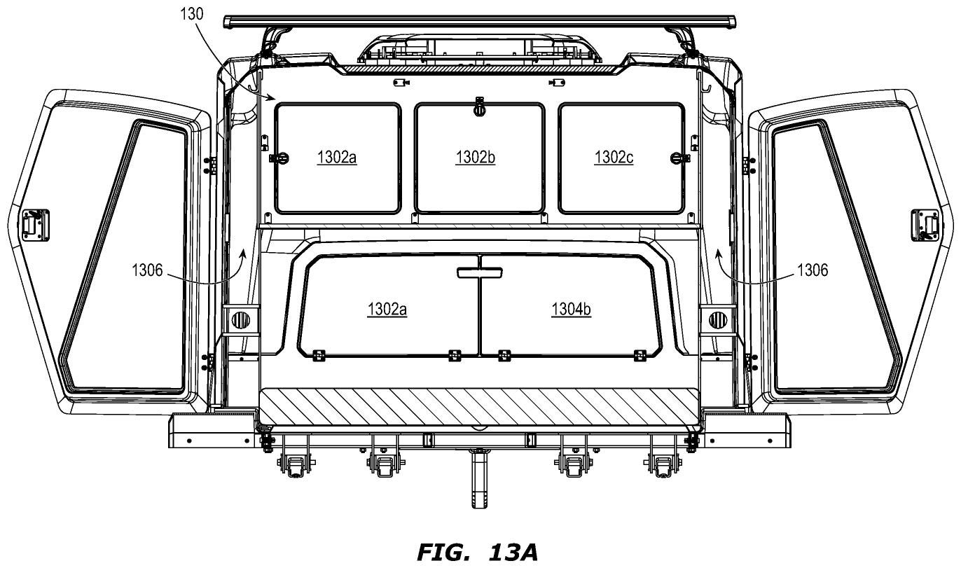

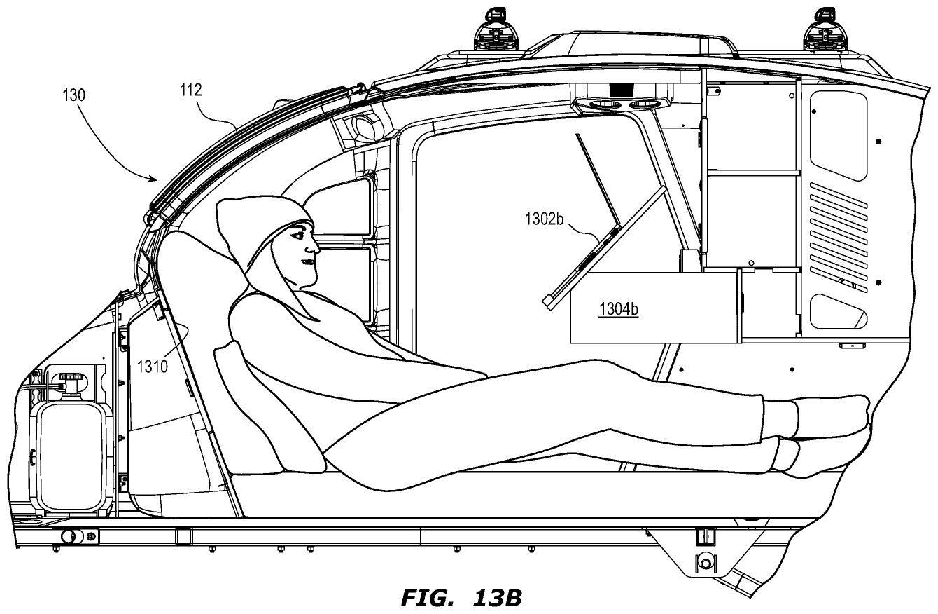

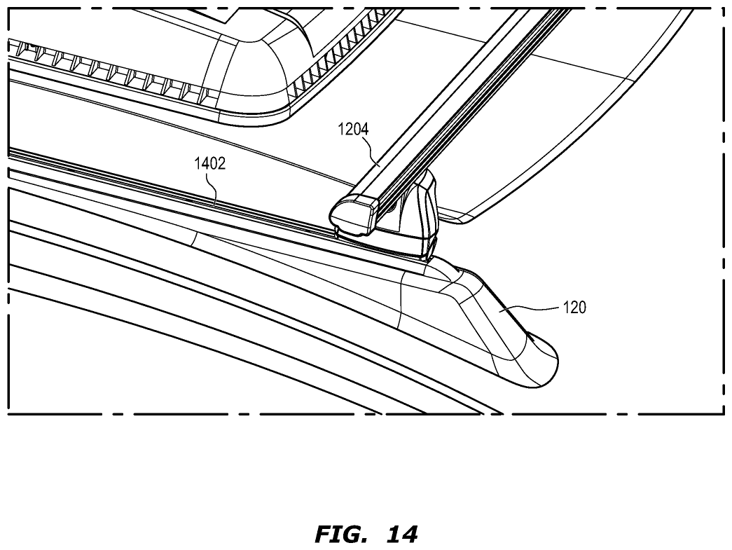

FIG. 13A depicts a segmentation view of one embodiment of an interior 130 of the trailer 100. In one embodiment, the interior 130 includes upper and lower storage compartments (collectively 1302, 1304) made of HDPE and lightweight honeycomb composite that are CNC precision cut with mortise and tenon construction for added strength. In the depicted embodiment, three larger upper cabinets 1302a-c and two lower cabinets 1304a-b are included. In one embodiment, when the middle upper cabinet door 1302b is hinged open it folds down and rests on the angles cut into the two lower cabinet doors 1304a-b when they are open, creating a convenient mounting surface for laptops, tablet computers, books, writing, and/or the like. In one embodiment, the two lower cabinets 1304a-b include metal plates that are attracted to two hidden magnets in the top door 1302b.

In further embodiments, the interior 130 includes built-in nightstands. In one embodiment, a true queen-sized mattress is included, and the bed frame may include an angled headboard where a user can lay back and stare at the night sky through a window 112, e.g., a 2.5′×5′ stargazer window. In certain embodiments, the interior includes 42½ inches of headroom.

In one embodiment, the interior 130 includes a heated mudroom at each entry-door. In one embodiment, a strategically designed utility space (e.g., with dimensions 4.5″×32″) provide a perch for the user's feet to assist the user as the user removes their shoes. In certain embodiments, two coat hooks at each entry are included. The cabinets 1304, 1302, in one embodiment, provide nearly eight cubic feet of cabinet space. In one embodiment, storage space is provided behind the headboard, e.g., about five cubic feet. In certain embodiments, the cabinets 1302, 1304 include Baltic birch cabinet faces.

FIG. 13B depicts another perspective of the cabin interior 130. In the depicted embodiment, the middle upper cabinet door 1302b is hinged open and folded down to rest on the angles cut into the two lower cabinet doors 1304a-b when they are open, creating a convenient mounting surface for laptops, tablet computers, books, writing, and/or the like. In further embodiments, the angled headboard 1310 is shown, which can be used to rest against and is removable to access a storage compartment for extra storage space.

FIG. 14 depicts one embodiment of a roof rack system. In one embodiment, one or more rails 1402 are molded into, bolted to, or otherwise mechanically attached to the elongated protrusions 120 that are formed in the body 102. The rails 1402 provide an interface to receive roof rack mounting rails 1204, which are used to secure cargo to the roof of the trailer body 102.

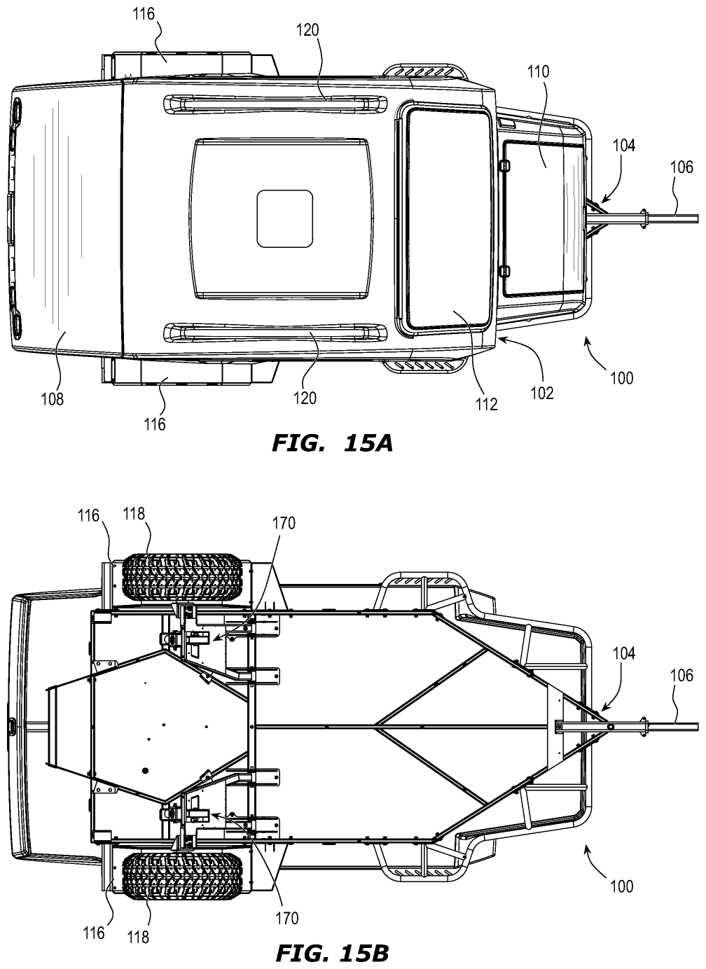

FIGS. 15A and 15B show an overhead view of the trailer 100 and an underside view of the trailer 100, respectively. In one embodiment, the unique structure of the trailer frame 104 is shown. As described above, in one embodiment, the trailer frame 104 includes a hot-dip galvanized tube steel frame. In one embodiment, the monocoque trailer body 102 bolts or otherwise mechanically couples directly to the trailer frame 104, adding stiffness without adding unnecessary weight. In one embodiment, the fenders 116 are bolted into the trailer frame 104.

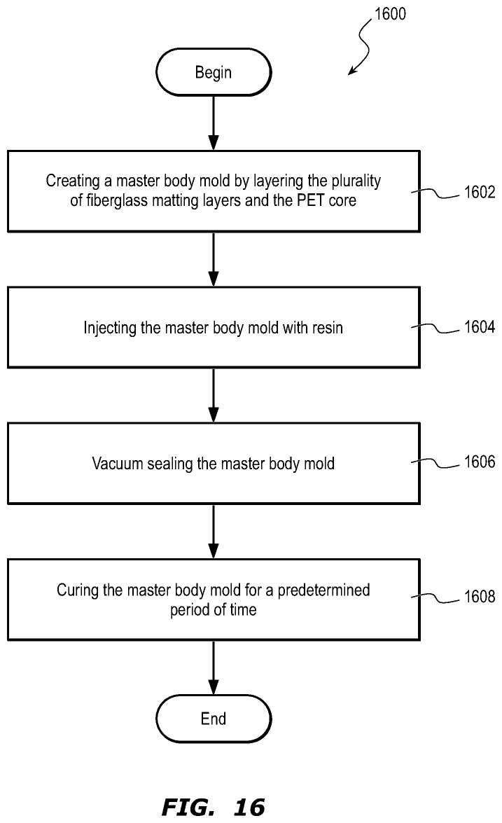

FIG. 16 depicts one embodiment of a method 1600 for forming a trailer body. In one embodiment, the method 1600 begins and creates 1602 a master body mold by layering the plurality of fiberglass matting layers and the PET core (e.g., which may be made of recycled milk cartons). In one embodiment, the method 1600 injects 1604 the master body mold with resin. In one embodiment, the method 1600 vacuum seals 1606 the master body mold. In one embodiment, the method 1600 cures 1608 the master body mold for a predetermined period of time, and the method 1600 ends.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C. As used herein, “a member selected from the group consisting of A, B, and C and combinations thereof” includes only A, only B, only C, a combination of A and B, a combination of B and C, a combination of A and C or a combination of A, B and C.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A trailer comprising:
a trailer frame; and
a body coupled to the trailer frame, the body comprising a monocoque structure that is molded from a plurality of material layers, the molded body comprising at least one access and a storage compartment located towards a tongue of the trailer frame.

2. The trailer of claim 1, wherein the plurality of layers comprises fiberglass matting that has a low-density polyethylene terephthalate (“PET”) core positioned between an inner layer and an outer layer of the plurality of layers of fiberglass matting such that the body is structurally rigid and insulated.

3. The trailer of claim 1, wherein the body comprises at least one accessory point molded into the body, the at least one accessory point comprising one or more of a magnet, a hook, an eye, and a clip.

4. The trailer of claim 1, wherein the body comprises a plurality of return flange mechanical gutters for each of the at least one accesses molded into the body, the plurality of return flange mechanical gutters configured to capture moisture and direct it away from the trailer without additional sealing materials around the at least one access.

5. The trailer of claim 1, wherein the body is further molded to form at least one of an interior cabin, a rear galley, a rear galley access, a window, a roof rack system, and a roof access.

6. The trailer of claim 5, wherein the rear galley comprises a kitchen, the kitchen comprising one or more of a sink, a stove, a cooler, a table, and one or more cabinets.

7. The trailer of claim 6, wherein the table forms a removable cabinet door for a cabinet of the rear galley, the table comprising an adjustable fold-out leg on a first side and a mounting point along an edge of the table for mounting to a side of the trailer.

8. The trailer of claim 7, wherein the edge of the table that mounts to the side of the body comprises a metal edge that selectively couples to a corresponding mounting point on the fender.

9. The trailer of claim 5, wherein the roof rack system comprises a pair of oppositely located elongated protrusions on the roof of the body that are molded as part of the body and provide an elevated flat surface for mounting items to the roof.

10. The trailer of claim 9, further comprising at least one adjustable rail that is couplable to the pair of elongated protrusions and spans a width of the roof between the pair of elongated protrusions for securing items mounted to the roof.

11. The trailer of claim 1, further comprising a trailing arm style suspension system coupled to the frame, the suspension system comprising Delrin bushings, eccentric bolts for toe and camber wheel alignment, an angled shock-in-spring mount, and built-in rock sliders for protection of the suspension components.

12. The trailer of claim 1, further comprising a hidden galley hinge system that mounts to an interior of the body and the rear galley hatch door such that when activated the hinge extends outward and upward, clearing the galley hatch door from the rest of the body.

13. The trailer of claim 1, further comprising a solar panel coupled to an exterior surface of the body for providing power to electrical components of the trailer.

14. The trailer of claim 1, wherein an interior of the trailer comprises a plurality of storage compartments that comprise three upper storage cabinets and two lower storage cabinets, each storage cabinet having a hinged door.

15. The trailer of claim 14, wherein the middle upper cabinet door, when hinged open, folds down and rests onto an angle cut into the two lower cabinet doors, creating an angled surface for resting an object, the two lower cabinets comprising metal plates that are selectively coupled to two hidden magnets in the middle upper cabinet door.

16. The trailer of claim 1, wherein the at least one access comprises a doorway to an interior of the trailer, an interior edge of the doorway lined with magnetic material for attaching accessories along the doorway.

17. The trailer of claim 16, further comprising a door for the doorway, the door comprising a window that includes an edge that is lined with magnetic material for attaching accessories on the window.

18. The trailer of claim 17, wherein the accessories comprise a screen that has magnetic material along an edge of the screen and is sized to fit one of the doorway and the window.

19. A system, comprising:
a trailer frame;
a body coupled to the trailer frame, the body comprising a monocoque structure that is molded from a plurality of material layers, the molded body comprising:
at least one access and a storage compartment located towards a tongue of the trailer frame; and
a plurality of return flange mechanical gutters for each of the at least one accesses configured to capture moisture and direct it away from the trailer without additional sealing materials around the at least one access; and
a trailing arm style suspension system coupled to the trailer frame and each wheel, the trailing arm style suspension system comprising independent suspension for each wheel of the trailer.

20. A method for forming a monocoque structure, comprising:
creating a master body mold by layering a plurality of fiberglass matting layers and a polyethylene terephthalate (“PET”) core;
injecting the master body mold with resin;
vacuum sealing the master body mold; and
curing the master body mold for a predetermined period of time.
